(19) United States
(12) Patent Application Publication
(10) Pub. No.: US 2014/0282246 A1
(43) Pub. Date: Sep. 18, 2014

(54) LIST FOR TOUCH SCREENS

(71) Applicants: Qing Gong, Cary, NC (US); Huifang Wang, Cary, NC (US)

(72) Inventors: Qing Gong, Cary, NC (US); Huifang Wang, Cary, NC (US)

(73) Assignee: SAS Institute Inc., Cary, NC (US)

(21) Appl. No.: 14/177,580

(22) Filed: Feb. 11, 2014

Related U.S. Application Data
(60) Provisional application No. 61/778,400, filed on Mar. 12, 2013.
(60) Provisional application No. 61/827,397, filed on May 24, 2013.

(51) Int. Cl. G06F 3/0482; G06F 3/0488; G06F 3/0484

(52) U.S. Cl. CPC G06F 3/0482; G06F 3/04842; G06F 3/0488
USPC 715/815

(57) ABSTRACT

Various embodiments are generally directed to techniques for increasing the accuracy with which list items may be selected on a touch screen. A machine-readable storage medium includes instructions that when executed cause a computing device to present a list of multiple list items on a touch screen, each associated with a touch area and including a wide area marking a location of the touch area and a narrow area narrower than the wide area, the wide and narrow areas defining a presentation area wherein the wide areas of adjacent first and second list items are positioned at different first and second widthwise positions, respectively, and wherein the touch areas of the first and second list items coincide with the wide areas of the first and second list items, respectively. Other embodiments are described and claimed.

### CROSS-REFERENCE TO RELATED APPLICATIONS

This application claims the benefit of priority under 35 U.S.C. §119(e) to U.S. Provisional Application Ser. No. 61/827,397 entitled LIST FOR TOUCH SCREENS filed May 24, 2013, the disclosure of which is incorporated herein by reference.

This application also claims the benefit of priority under 35 U.S.C. §119(e) to U.S. Provisional Application Ser. No. 61/778,400 entitled LIST FOR TOUCH SCREEN filed Mar. 12, 2013, the disclosure of which is incorporated herein by reference.

This application is related to U.S. patent application Ser. No. ______ filed concurrently herewith entitled LIST FOR TOUCH SCREENS, which is incorporated herein by reference in its entirety.

### BACKGROUND

The use of touch screens in hand-held computing devices has become sufficiently commonplace as to begin supplanting other forms of manually-operable input devices (e.g., keyboards, keypads, trackballs, joysticks, etc.) in such computing devices. Touch screens enable items in a graphical user interface (GUI) to be visually presented and made selectable by acting on the natural instinct to directly touch items that are of interest. Improvements in display technology have brought increases in pixel densities enabling greater quantities of items to be visually presented in a relatively small display area, often by reducing the size of the display area occupied by each item. Although such reductions in size may not necessarily challenge to the acuity of many users, it can present a challenge in accurately selecting items using the tips of users' digits.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

A computer-implemented method includes presenting a list that includes multiple list items on a touch screen, each list item of the multiple list items associated with a touch area, and each list item including a wide area having a first thickness dimension marking a location of the associated touch area and a narrow area having a second thickness dimension narrower than the first thickness dimension. The wide and narrow areas adjoin to define a presentation area wherein the wide area of a first list item of the multiple list items is positioned at a first widthwise position of the presentation area of the first list item, the wide area of a second list item of the multiple list items is positioned at a second widthwise position of the presentation area of the second list item, the second list item is adjacent the first list item in the list, and the first widthwise position differs from the second widthwise position along a widthwise dimension of the list. The computer-implemented method further includes defining the touch area of the first list item to coincide with the wide area of the first list item, and defining the touch area of the second list item to coincide with the wide area of the second list item.

An apparatus includes a processor component; a presentation component for execution by the processor component to present a list that includes multiple list items arranged along a lengthwise dimension of the list on a touch screen, to position a first wide area of a first list item of the multiple list items at a first widthwise position of a first presentation area of the first list item, and to position a second wide area of a second list item of the multiple list items at a second widthwise position of a second presentation area of the second list item, the second list item adjacent the first list item in the list, and the second widthwise position differing from the first widthwise position along a widthwise dimension transverse to the lengthwise dimension; and a touch component for execution by the processor component to define a first touch area associated with the first list item to coincide with the first wide area, and to define a second touch area associated with the second list item to coincide with the second wide area.

At least one non-transitory machine-readable storage medium includes instructions that when executed by a computing device, cause the computing device to present a list that includes multiple list items on a touch screen, each list item of the multiple list items associated with a touch area, and each list item including a wide area having a first thickness dimension marking a location of the associated touch area and a narrow area having a second thickness dimension narrower than the first thickness dimension. The wide and narrow areas adjoin to define a presentation area wherein the wide area of a first list item of the multiple list items is positioned at a first widthwise position of the presentation area of the first list item, the wide area of a second list item of the multiple list items is positioned at a second widthwise position of the presentation area of the second list item, the second list item is adjacent the first list item in the list, and the first widthwise position differs from the second widthwise position along a widthwise dimension of the list. The computing device is further caused to define the touch area of the first list item to coincide with the wide area of the first list item, and define the touch area of the second list item to coincide with the wide area of the second list item.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other features will become apparent from the following detailed description when considered in conjunction with the drawings.

### BRIEF DESCRIPTION OF THE DRAWINGS

FIG. 1 illustrates an example of an embodiment of a touch-controlled system.

FIGS. 2 and 3, together, illustrate an example of an embodiment of a list.

FIGS. 4A-B illustrate examples of alternate embodiments of the list of FIGS. 2 and 3.

FIGS. 5A-B illustrate examples of alternate embodiments of lists.

FIG. 6 illustrates an example of an alternate embodiment of a list.

FIGS. 7A-B illustrate examples of alternate embodiments of the list of FIG. 6.

FIG. 8 illustrates an example of a file directory incorporating a list according to an embodiment.

FIG. 9 illustrates an example of a table incorporating a pair of lists according to an embodiment.

FIG. 10 illustrates an example of an embodiment of an operating environment for a touch-controlled system.

FIG. 11 illustrates an example of an embodiment of a first logic flow.

FIG. 12 illustrates an example of an embodiment of a second logic flow.

FIG. 13 illustrates an example of an embodiment of a third logic flow.

### DETAILED DESCRIPTION

Various embodiments are generally directed to techniques for increasing the accuracy with which list items visually presented in a relatively dense list may be selected on a touch screen. Each list item is visually presented on a display element of the touch screen with a presentation area made up of a narrow area and a wide area. The narrow areas of the list items are arranged along a lengthwise dimension of the list, while the wide areas are positioned at locations along a widthwise dimension of the list that alternate between adjacent list items such that the wide areas are positioned at alternating staggered locations. Each list item is also associated with a touch area defined on a touch element co-located with the display element. Each touch area is shaped, sized and/or positioned to substantially coincide with the shape, size and/or position of at least the wide area of a corresponding one of the list items, enabling an operator to select a list item by touching the touch screen at a location coinciding at least with its associated wide area.

The presentation areas are marked with boundary markers to make the locations of at least the wide areas visible to an operator to assist with selecting a list item by touching at least its associated wide area. In some embodiments, the touch areas may be extended to also coincide with narrow areas and the presentation areas may be further marked with boundary markers to also make the locations of the narrow areas visible to an operator. This may be done to enable the operator to select a list item by touching its associated narrow area in embodiments in which the operator may be assisted in doing so with a stylus. In some of such embodiments, an operator may be provided with the option to indicate to the hand-held device whether the ability to select a list item by touching its associated narrow area is enabled. Thus, whether a touch area is extended to coincide with a narrow area, as well as a wide area, of a corresponding presentation area may be made selectable by an operator.

The combination of a narrow area and a wide area may give the presentation area of each list item a generally elongate shape oriented to extend widthwise across the list and in which its thickness varies from end to end along its length. In some embodiments, the positioning of the wide areas at alternating widthwise positions between adjacent list items may be accomplished through positioning of the wide areas at alternating ends of the generally elongate shape of the presentation areas of the list items. In other embodiments, the positioning of the wide areas at alternating widthwise positions may create pairs of adjacent presentation areas of identical irregular shape that “interlock” in the manner in which they border each other.

The width of the list as visually presented on a touch screen may be at least partly determined by the length of the item text of one or more of the list items. By way of example, specifications of the size of characters of a font used in visually presenting item texts of list items and/or a determination of the length of the longest item text among all of the list items of a list may be employed to determine at least a minimum width of the list. Alternatively or additionally, dimensions of the touch screen and/or settings employed in visually presenting items on the touch screen may impose a maximum width of the list, and that maximum width may override such a minimum width where the minimum width is greater than the maximum width. Regardless of the exact manner in which the width of the list is determined, the width of the list may be employed as a factor in determining at least one of the alternating widthwise positions at which the wide areas may be positioned along the lengths of the list items. Alternatively or additionally, the width of the list may be employed as a factor in determining how many different alternating positions are used in visually presenting the list.

The thickness of the narrow and/or wide areas as visually presented on a touch screen may also be at least partly determined by the size of characters of a font used in visually presenting item texts. By way of example, the size of characters of the font may be employed as a basis for determining the narrower thickness of narrow areas of the list items. Then, the wider thickness of wide areas of the list items may be determined by multiplying the narrower thickness with a constant. Regardless of the exact manner in which the wider thickness of the wide areas is determined, the size of the corresponding touch areas may be at least partly determined from the wider thickness. In some embodiments, at least a thickness dimension of the touch areas may be selected to match the wider thickness of the wide areas or may be otherwise derived from the wider thickness of the wide areas.

Upon visual presentation of the list on the display element of the touch screen, the touch areas associated with each of the list items are monitored to detect an indication of a touch to select one of the list items. In response, any of a variety of actions may be taken based on the nature of the list item selected. By way of example, where the selected list item is a link to data, at least a portion of that data may be visually presented on the touch screen. Where the selected item is a routine executable by a processor component, execution of that routine may be initiated.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical communications capable of being stored, transferred, combined, compared, and otherwise manipulated. It proves convenient at times, principally for reasons of common usage, to refer to what is communicated as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

FIG. 1 illustrates a block diagram of an embodiment of a touch-controlled system 1000 incorporating one or more servers 300a-e and/or a computing device 500. Each of these computing devices may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc. Embodiments are not limited in this context.

As depicted, these computing devices 300a-e and 500 exchange communications conveying item data 330 to be visually presented on a touch screen through a network 999. However, one or more of the computing devices 300a-e and 500 may exchange other entirely unrelated data with each other and/or with still other computing devices (not shown) via the network 999. In various embodiments, the network 999 may be a single network that may extend within a single building or other relatively limited area, a combination of connected networks that may extend a considerable distance, and/or may include the Internet. Thus, the network 999 may be based on any of a variety (or combination) of communications technologies by which communications may be effect, including without limitation, wired technologies employing electrically and/or optically conductive cabling, and wireless technologies employing infrared, radio frequency or other forms of wireless transmission.

The item data 330 may be any of a variety of types of data, including and not limited to, email addresses and/or other indications of destinations to which to electronically send information, physical addresses of locations, names of persons, titles of books or other creative works, collected or raw data, results of calculations, entries of a list or chapters or an index, etc. The item data 330 may simply be stored within one or more of the servers 300a-e awaiting retrieval by the computing device 500. Alternatively, the item data 330 may be compiled or otherwise derived from a search of greater quantities of data maintained by one or more of the servers 300a-e, the search conducted among one or more of the servers 300a-e in response to a request transmitted from the computing device 500. It should be noted that although a quantity of five servers 300a-e is specifically depicted, other quantities of computing devices may be employed in deriving and/or providing the item data 330 to the computing device 500.

In various embodiments, the computing device 500 incorporates one or more of a processor component 550, a storage 560, a touch interface 575, a touch screen 580, a display interface 585, a graphics controller 600 and an interface 590 to couple the computing device 500 to the network 999. The touch screen 580 incorporates a touch element 571 and a display element 581. The storage 560 may store one or more of each of the item data 330, an application routine 510, settings data 530 and a user interface (UI) routine 540. The graphics controller 600, if present, incorporates one or more of a processor component 650 and a storage 660. The storage 660 of the graphics controller 600 (again, if present) stores one or more of a graphics routine 640. It is to be understood that although only one each of the application routine 510 and the UI routine 540 are depicted, various embodiments may incorporate more than one of each.

The display element 581 may any of a variety of “flat panel” or other type of display element based on any of a variety of technologies, including and not limited to, a cathode-ray tube (CRT), an electroluminescent (EL) panel, a liquid crystal display (LCD), etc. The touch element 571 is combined with the display element 581 to provide a touch-sensitive input capability. The touch element 571 may be a substantially transparent overlay film incorporating resistive, capacitive, or other touch-sensitive technology to detect instances of a digit of a hand and/or other object (e.g., a stylus) touching the touch screen 580. Alternatively, the touch element 571 may be made up of a combination of infrared (IR) or other light emitting and receiving components positioned about the periphery of the display element 581 to create a grid of beams to detect a touch of the display element 581 by detecting the accompanying interruption of one or more of the beams. The display interface 585 is coupled to the display element 581 to drive an image onto the display element 581 to visually present it. The touch interface 575 is coupled to the touch element 571 to assist in monitoring the touch-sensitive surface of the touch element 571 to detect an instance of a touch, and to assist in determining the location of that touch on the touch-sensitive surface.

The one or more application routines 510 and the one or more UI routines 540 each incorporate a sequence of instructions operative on the processor component 550 to implement logic to perform various functions. Each of the one or more application routines 510 may be any of a variety of applications that make use of a display to visually present a list of list items, including and not limited to, a database query application, a spreadsheet application, a storage device content viewer, etc. Each of the one or more UI routines 540 may be a UI component of the application routine 510, a UI component of an operating system (OS) operative on the processor component 550, etc.

The processor component 550 executes at least one application routine 510 and at least one UI routine 540, and may execute multiple ones of each sequentially or concurrently. In executing the application routine 510, the processor component 550 may receive at least a portion of the item data 330 from one or more of the servers 300a-e, as previously discussed. Alternatively or additionally, in executing the application routine 510, the processor component 550 may generate at least a portion of the item data 330. Regardless of the exact manner in which the item data 330 is received and/or generated, at least a portion of the item data 330 is conveyed from the application routine 510 to the UI routine 540 to be visually presented on the display element 581 in a list 832 as part of a visually presented image 830. The processor component 550, in executing the UI routine 540, then provides the visual portion of a graphical user interface (GUI) on the touch screen 580 that entails visually presenting the list 832 of list items 834 taken from at least that portion of the item data 330 on the touch screen 580.

FIG. 2 illustrates an example of the image 830 as visually presented on the touch screen 580, including an embodiment of the list 832. As depicted, the list 832 includes the list items 834, each of which includes a presentation area 837 made up of both a narrow area 838 and a wide area 839. Item text 836 unique to each list item 834 is visually presented within each of the presentation areas 837, and the boundaries of each of presentation areas 837 may be marked with boundary markers 835. As depicted, the boundary markers 835 are made up of solid lines that fully enclose each presentation area 837. However, in other embodiments, the boundary markers 835 may take other forms (e.g., dotted and/or dash lines, dots or other visible markings solely at corners, boundaries between differently colored areas, etc.).

The list 832 has a lengthwise dimension 812 that may become longer or shorter depending on the quantity of list items 834 included therein. The list 832 also has a widthwise dimension 813 that may be at least partly determined by the length of the longest item text 836 of the list items 834 visually presented and/or by a predetermined maximum width for any list that may be visually presented. The maximum width may be at least partly based on a dimension of the viewable area of the display element 581, which may be indicated in the settings data 530. The length of the lengthwise dimension 812 may be determinable from the narrower thickness dimension 818 multiplied by the quantity of list items 834 to be visually presented. Within each of the list items 834, the narrow area 838 has a narrow thickness dimension 818 that is less than the wide thickness dimension 819 of the wide area 839. Overall, the combination of the narrow area 838 and the wide area 839 in various embodiments may give the presentation area 837 an irregular and/or generally elongate shape that extends transverse to the orientation of the lengthwise dimension 812 and parallel to the orientation of the widthwise dimension 813 of the list 832. Stated differently, the generally elongate shape of each of the list items 834 extends widthwise across the list 832.

In executing the UI routine 540 to visually present the list 832, the processor component 550 may retrieve indications of dimensions of the font employed in visually presenting item text 836 from the settings data 530. From such indications, the processor component 550 may determine the narrow thickness dimension 818, and therefrom, may further determine the lengthwise dimension 812. Alternatively or additionally, the processor component 550 may multiply the narrow thickness dimension 818 by a selected constant to also determine the wide thickness dimension 819, or may retrieve the wide thickness dimension 819 from the settings data 530. From the indications of font dimensions, the processor component 550 may also determine a minimum width of the widthwise dimension 813 required to enable all characters in the longest of the item texts 836 to be visually presented. However, in response to instances in which such a minimum width exceeds a maximum width (e.g., a maximum width determined at least partly by dimensions of the viewable area of the display element 581), the widthwise dimension 813 may be limited to the maximum width. In such instances, part of the item text 836 of one or more of the list items 834 may be replaced with ellipses (e.g., “ . . . ”) or another visual indicator of truncation of text.

Regardless of the manner in which the widthwise dimension 813 is retrieved and/or derived, the processor component 550 may employ the widthwise dimension 813 to determine one or more alternating locations 833 along the widthwise dimension 813 at which the wide areas 839 may be positioned among adjacent ones of the list items 834. As previously discussed, different ones of the alternating locations 833 of the wide area 839 within each of the list items 834 are made up of different positions along the widthwise dimension 813, along which the length of the generally elongate shape of each of the list items 834 extends. Stated differently, different ones of the alternating locations 833 of the wide area 839 within each of the list items 834 include different positions along the length of each of the list items 834. As also previously discussed, the different ones of the alternating locations 833 are selected to “stagger” the locations of the wide areas 839 of adjacent ones of the list items 834 such that the wide areas 839 of adjacent list items 834 are positioned at different ones of the alternating locations 833. As a result, there are no instances in which the wide areas 839 of adjacent ones of the list items 834 align along a line extending parallel to the lengthwise dimension 812 such the wide areas 839 of adjacent ones of the list items 834 would overlap.

In the example of the list 832 depicted in FIG. 2, there are only two alternating locations 833 at which the wide area 839 may be positioned along the widthwise dimension 813 within each of the presentation areas 837 of each of the list items 834, and those alternating locations 833 are at the opposite ends of the generally elongate shape of the presentation areas 837. However, as will be explained in greater detail, other alternating locations 833 along the length of the list items 834 (e.g., along the widthwise dimension 813) are possible in other embodiments. In such other embodiments, the alternating locations 833 may be positioned equidistantly along the length of the presentation areas 837.

Returning to FIG. 1, in embodiments that include the graphics controller 600, the processor component 550 may be caused by further execution of the UI routine 540 to effect the visual presentation of the visual portion of a GUI that includes the visual presentation of the list 832 by triggering the graphics controller 600 to render the list 832 on to the display element 581. In so doing, the processor component 550 may convey indications to the graphics controller 600 of various ones of the dimensions 812, 813, 818 and 819 and/or indications of the derived alternating locations 833 of the wide areas 839 within the list items 834. Also, in so doing, the processor component 550 may convey indications of the item text 836 and/or locations of the boundary markers 835 for each of the list items 834. In response, the processor component 650 of the graphics controller, in executing the graphics routine 640, generates the image 830 and then operates the display interface 585 to drive the image 830 onto the display element 581, thereby effecting the visual presentation of the list 832. However, in alternate embodiments that do not include or do not make use of the graphics controller 600, the processor component 550 may itself render the list 832 onto the display element 581. Thus, the processor component 550 may itself generate the image 830, and then operate the display interface 585 to drive the image 830 onto the display element 581 to visually present the list 832.

Along with visually presenting the list 832, the processor component 550 may also operate the touch interface 575 to receive from the touch interface 575 an indication of a touch of a touch-sensitive surface of the touch element 571 that is indicative of a touch to select a list item 534. The processor component 550 associates different portions of the touch-sensitive surface of the touch element 571 with each of the list items 534, thereby effectively defining touch areas associated with each of the list items 534 at which a touch may be taken as a selection of one of the list items 534. Stated differently, the processor component 550 may also effect the user input component of a GUI coinciding with the visual presentation of the visual portion just discussed. FIG. 3 illustrates an example of correspondence between a wide area 539 of a list item 534 of the example embodiment of the list 532 of FIG. 2 and a touch area 847 of the same list item 534. As depicted, an example of the touch element 571 may be implemented as a transparent film using any of a variety of touch sensing technologies that is overlain atop the viewable area of the display element 581.

In executing the UI routine 540, the processor component 550 operates the touch interface 575 to define the shape, size and/or position of the touch area 847 to coincide with at least the wide area 839 of the list item 834. As depicted, such coincidence arises from the touch area 847 being defined to overlie at least a portion of the wide area 839. As has been discussed, the touch area 847 may additionally coincide with the narrow area 838 such that the touch area 847 may correspond to the substantially all of the presentation area 837 in shape, size and/or position. As has also been discussed, whether the touch area 847 also coincides with the narrow area 838 may be made selectable by an operator.

In defining the touch area 847, the processor component 550 may derive the shape, size and/or position of the touch area 847 from the shape, size and/or position of at least the wide area 839. More specifically, the processor component 550 may derive a thickness dimension 849 of the touch area 847 from the wide thickness dimension 819 of the wide area 839. The thickness dimension 849 may be selected to match the wide thickness dimension 819. Alternatively, the thickness dimension 849 may be derived by multiplying the wide thickness dimension 819 with a constant and/or by subtracting a constant therefrom such that the thickness dimension 849 may be somewhat less than the wide thickness dimension 819 to provide some distance between the touch area 847 and another nearby touch area. As depicted, the boundary markers 835 marker boundaries of at least the wide area 839 such that an operator is guided to touch at the location of the wide area 839, and thus, touch at the location of the touch area 847.

In various embodiments, each of the processor components 550 and 650 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are linked.

Although each of the processor components 550 and 650 may include any of a variety of types of processor, it is envisioned that the processor component 650 of the graphics controller 600 of the computing device 500 may be somewhat specialized and/or optimized to perform tasks related to graphics, including graphics rendering. More broadly, it is envisioned that the controller 600 servers as a graphics subsystem of the computing device 500 to enable the performance of tasks related at least to graphics rendering, using components separate and distinct from the processor component 550 and its more closely related components.

In various embodiments, each of the storages 560 and 660 may be based on any of a wide variety of information storage technologies, including volatile technologies requiring the uninterrupted provision of electric power, and/or including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the interface 590 may employ any of a wide variety of communications technologies enabling these computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ timings and/or protocols conforming to any of a variety of industry standards, including without limitation, RS-232C, RS-422, USB, Ethernet (IEEE-802.3) or IEEE-1394. Where the use of wireless transmissions is entailed, these interfaces may employ timings and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

As previously discussed, FIGS. 2 and 3 illustrate one example embodiment of the list 832. As will now be discussed, FIGS. 4A-B, 5A-B, 6 and 7A-B illustrate alternate embodiments of the list 832 as visually presented on the touch screen 580. These alternate embodiments should be taken as examples, and should not be taken as limiting.

FIGS. 4A and 4B each illustrate embodiments of the list 832 that, like the embodiment of FIGS. 2 and 3, are each made up of list items 834 in which the wide areas 839 are positioned at an end of each of the generally elongate shapes of the presentation areas 837. In FIG. 4A, the alternating locations of the wide areas 839 alternate between being positioned at leftmost ends and rightmost ends of adjacent ones of the list items 834 in a manner substantially similar to the embodiment of FIGS. 2 and 3. However, the shape of the wide areas 839 of the embodiment of FIG. 4A is more rectangular, versus the more circular shape of the wide areas 839 of the embodiment of FIGS. 2 and 3. In FIG. 4B, the shape of the wide areas 839 is substantially similar to the circular shape of the wide areas of the embodiment of FIGS. 2 and 3, but all of the alternating locations 833 of the wide areas 839 within each of the list items 834 of the embodiment of FIG. 4B are positioned at or near the rightmost ends of the list items 834. Specifically, instead of alternating between leftmost and rightmost ends, the wide areas 839 of adjacent ones of the list items 834 in the embodiment of FIG. 4B alternate between being positioned at a rightmost end location and a location that is inset to the left of the rightmost location.

In FIG. 5A, the alternating locations of the wide areas 839 alternate between being positioned at leftmost ends and rightmost ends of adjacent ones of the list items 834 in a manner substantially similar to the embodiment of FIGS. 2 and 3. However, the shape of the wide areas 839 of the embodiment of FIG. 5A is more of a shaded half-circle, versus the unshaded and fuller circular shape of the wide areas 839 of the embodiment of FIGS. 2 and 3. In FIG. 5B, the shape of the wide areas 839 is substantially similar to the circular shape of the embodiment of FIGS. 2 and 3, but the wide areas 839 of the embodiment of FIG. 5B are shaded. Further, FIG. 5B illustrates an example embodiment in which there are more than two alternating locations 833 along the length of the list items 834 at which the wide areas 839 may be positioned. Specifically, three locations 833 are depicted within each of the list items 834 that include a leftmost location, another location inset to the right from the leftmost location, and still another location that is further inset to the right from the leftmost location (e.g., almost midway along the length of the generally elongate shape of the list items 834). As previously discussed, the processor component 550 may derive one or more of the alternating locations 833 within the presentation areas 837 of each of the list items 834.

As can be readily appreciated in the examples illustrated by FIGS. 4B and 5B, even in embodiments in which the alternating locations 833 are not limited in quantity to two that are positioned at opposite ends of the list items 834, the alternating locations 833 are still positioned with sufficient distance between them to ensure that the wide areas 839 of adjacent ones of the list items 834 have sufficient separation along the widthwise dimension 813 to enhance the accuracy with which either of those adjacent list items 834 may be selected. Stated differently, with the wide areas 839 of adjacent list items 834 positioned at different ones of the alternating locations 833, there is sufficient room in the widthwise dimension 813 to define their corresponding touch areas 847 to have shapes and sizes that are sufficiently large as to enhance the accuracy with which either of the adjacent list items 834 may be selected. Thus, in essence, the widthwise dimension 813 is used to provide the necessary room for the touch areas 847 that is not provided along the lengthwise dimension 812 due to the relatively dense arrangement of the list items 834 along the lengthwise dimension 812.

FIG. 6 illustrates an embodiment of the list 832 in which the narrow area 838 and the wide area 839 blend somewhat together as at least some of the boundary markers 835 separating adjacent ones of the list items 834 define presentation areas 837 having wedge-like shapes such that there is a gradual transition in the thickness dimension along their lengths. This gradual transition substantially differs from the more abrupt transitions therebetween in the embodiments of the list 832 illustrated in preceding figures.

FIGS. 7A and 7B each illustrate embodiments of the list 832 in which pairs of adjacent ones of the list items 834 have presentation areas 837 with irregular interlocking shapes. FIG. 7A illustrates an embodiment of the list 832 in which the narrow area 838 and the wide area 839 also blend somewhat together with a gradual transition in thickness somewhat like the embodiment of FIG. 6. However, instead of presentation areas 837 having the somewhat wedge-like shape of the embodiment of FIG. 6, at least some of the boundary lines 835 separating adjacent ones of the list items 834 define curving boundaries in which the wide areas 839 are given a convex shape and the narrow areas 838 are given a concave shape in the embodiment of FIG. 7A. These convex and concave shapes define interlocking boundaries between the presentation areas 837 of adjacent ones of the list items 834 as the convex shapes extend into the recesses of the concave shapes. It should be noted that other embodiments are possible in which the curving boundaries define more pairs of interlocking convex and concave shapes than are depicted in FIG. 7A, or in which the interlocking concave and convex shapes of FIG. 7A are spaced closer together along the widthwise dimension 813. FIG. 7B illustrates an embodiment of the list 832 in which a “stepped” boundary is defined by at least some of the boundary markers 835 separating adjacent ones of the list items 834, also providing an interlocking boundary between their presentation areas 837. It should be noted that other embodiments are possible in which the boundary between these presentation areas 837 define more than one step.

FIG. 8 illustrates an embodiment of the list 832 in which the list items 834 are touch-selectable items of a file system hierarchy such as a hierarchy of directories in a storage device in which files may be stored. As depicted, the item text 836 of at least some of the list items 834 is indented relative to others and/or augmented with item markers 831 to indicate directory-subdirectory relationships within such a hierarchy. In other words, indications of relationships between list items 834 may be visually presented in the presentation areas 837 in addition to item text 836. As also depicted, the presentation areas 837 of the list items 834 of the embodiment of the list 832 of FIG. 8 have a generally wedge-like shape not unlike the presentation areas 837 of the list items 834 of the embodiment of the list 832 of FIG. 6. The boundary markers 835 provide visual indications of the locations of the wide areas 839, and correspondingly, locations of coinciding touch areas 847 at which a touch to select one of the list items 834 (e.g., to select a directory or subdirectory) may be detected.

Still further, FIG. 8 depicts two example embodiments of a visual indication of one of the list items 834 being selected, specifically the list item 834 corresponding to the subdirectory “office” in the depicted hierarchy of directories. In each, an aspect of the visual presentation of the selected one of the list items 834 is altered to highlight it in a manner that visually differentiates it from the others of the list items 834. In one of these examples embodiments, the boundary markers 835 providing an indication of the shape and size of the presentation area 837 are highlighted (e.g., thickened or otherwise made darker or bolder, a change in color or shade of color, etc.). In the other of these examples, the presentation area 837 itself is highlighted (e.g., given a different color, different shade of color, made lighter or darker, etc.), and the characters of the item text 636 “office” may be highlighted (e.g., thickened or otherwise made darker or bolder, given a different font or color, etc.).

FIG. 9 illustrates an example of a two-dimensional table incorporating a pair of embodiments of the list 832, specifically as lists 832a and 832b in an example of a calendar spanning two weeks. The list items 834 of one of the lists 832a serves to label rows of the table (e.g., hours of a day), while list items 834 of the other of the lists 832b serves to label columns of the table (e.g., days of each of the two weeks). The shapes of the presentation areas 837 of the list items 834 of both of the lists 832a and 832b of FIG. 9 have an irregular shape not unlike the presentation areas 837 of the list items 834 of the embodiment of the list 832 of FIG. 4B. However, embodiments are not limited in this context.

FIG. 10 illustrates a block diagram of a portion of an embodiment of the touch-controlled system 1000 of FIG. 1 in greater detail. More specifically, FIG. 10 depicts aspects of the operating environment of the computing device 500 in which at least the processor component 550, in executing at least the UI routine 540, generates and renders at least one embodiment of the list 832 onto the touch screen 580. As recognizable to those skilled in the art, the UI routine 540, including the components of which each is composed, is selected to be operative on whatever type of processor or processors that are selected to implement the processor component 550.

In various embodiments, each of the application routine 510 and UI routine 540 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for the processor component 550. Where one or more device drivers are included, those device drivers may provide support for any of a variety of other components, whether hardware or software components, of the computing device 500.

The application routine 510 may include a communications component 519 executable by the processor component 550 to operate the interface 590 to transmit and receive communications via the network 999 as has been described. Among the communications may be those conveying the item data 330 among one or more of the computing devices 300a-e and 500 via the network 999. As will be recognized by those skilled in the art, the communications component is selected to be operable with whatever type of interface technology is selected to implement the interface 590.

In embodiments in which the item data 330 is received from another computing device (e.g., one or more of the servers 300a-e), the communications component 519 may so receive the item data 330 via the network 999. Upon such receipt of the item data 330, the communications component 519 and/or another component of the application routine 510 provides the item data 330 to the UI routine 540. The application routine 510 may trigger the UI routine 540 to visually present an image 830 that includes at least one embodiment of the list 832 onto the touch screen 580 and/or provide the application routine 510 with an indication of detection of a touch to select one of the list items 834.

The UI routine 540 may include a text sizing component 543 executable by the processor component 550 to determine one or more dimensions of item text 836 of list items 834 of an embodiment of the list 832. The list sizing component 543 may retrieve indications of a size or choice of a font to be used in visually present the item text 836 from the settings data 530, and calculate the height of the tallest text character(s) among the item texts 836 of the list items 834. The choice and/or size of the font may be selectable by an operator of the computing device 500 such that one or both may change over time. The list sizing component 543 may also identify the longest item texts 836 among the list items 834 and calculate a minimum length required of the presentation areas 837 of the list items 834 to fit the longest of the item texts 836.

The UI routine 540 may include a list sizing component 544 executable by the processor component 550 to determine one or more dimensions of an embodiment of a list 832 and/or the presentation areas 837 of its list items 834. The list sizing component 544 may receive an indication of a height of the tallest text character(s) among the items texts 836 from the text sizing component 543 and determine the narrow thickness dimension 818 of the narrow area 838 and/or the wide thickness dimension 819 of the wide area 839 of the presentation areas 837 of the list items 834 therefrom. The list sizing component 544 may further determine the lengthwise dimension 812 of the embodiment of the list 832 from one or more of the narrow thickness dimension 818, the wide thickness dimension 819 and the quantity of list items 834 to be visually presented at any given time. In some embodiments, the lengthwise dimension 812 may be determined by multiplying the narrow thickness dimension 818 by the quantity of list items 834 to be visually presented. In other embodiments, a combination of the narrow thickness dimension 818 and the wide thickness dimension 819 may be used.

The list sizing component 544 may receive an indication of a minimum length required of the presentation areas 837 of the list items 834 to fit the longest of the item texts 836. Stated differently, the list sizing component 544 may receive an indication of a minimum width required of the embodiment of the list 832 to accommodate presentation areas 837 having such a minimum length, and this minimum width may become the widthwise dimension 813. However, the list sizing component 544 may also retrieve an indication from the settings data 530 (or elsewhere) of a dimension of the viewable area of the display element 581, and that dimension may impose a maximum width for the embodiment of the list 832 that is less than the minimum width required to accommodate such presentation areas 837. In response, to such a maximum width being less than such a minimum width, the list sizing component 544 may select the maximum width as the widthwise dimension 813 or otherwise base the widthwise dimension 813 on the maximum width.

The UI routine 540 may include a positioning component 545 executable by the processor component 550 to determine the alternating locations 833 along the lengths of the elongate shapes of the presentation areas 837 at which the wide areas 839 may be positioned. In so doing, the positioning component 545 may use the widthwise dimension 813, regardless of the manner in which the widthwise dimension 813 is determined by the list sizing component 544. More specifically, in embodiments in which the quantity of alternating locations 833 is not predetermined to be two (e.g., in embodiments in which the alternating locations 833 are not limited to being only at the endmost locations of the presentation areas 837), the positioning component 545 may determine the quantity of the alternating locations 833 based on the widthwise dimension 813.

The UI routine 540 may include a presentation component 548 executable by the processor component 550 to visually present the embodiment of the list 832. The presentation component 548 may employ one or both of the lengthwise dimension 812 and the widthwise dimension 813 to determine a position and/or orientation at which to visually present the embodiment of the list 832 on the display element 581. The presentation component 548 may employ the narrow thickness dimension 818 and/or the wide thickness dimension 819 to determine where to position the list items 834, including their item texts 836, within the position of the embodiment of the list 832. The presentation component 548 also employs the narrow thickness dimension 818, the wide thickness dimension 819 and/or indications of the alternating positions 833 at which the wide areas 839 are to be positioned along the lengths of the presentation areas 837 of the list items 834 to shape, size and/or position the wide areas 839 of each of the list items 834. More specifically, the presentation component 548 employs the narrow thickness dimension 818, the wide thickness dimension 819 and/or indications of the alternating positions 833 to determine where to position the boundary markers 835 to provide visual indications of the boundaries of at least the wide areas 839. The presentation component 548 then operates the display interface 585 to effect the visual presentation of the embodiment of the list 832 with the list items 834, the boundary markers 835, the item texts 836 and/or other visible elements positioned at the positions determined by the presentation component 548.

The UI routine may include a touch component 547 executable by the processor component 550 to define shapes, sizes and/or positions of the touch areas 847 associated with the list items 834 visually presented by the presentation component 548 on the display element 581. The touch component 547 may be provided by the presentation component 548 with indications of the shape, size and/or locations at which at least the wide areas 839 are positioned, and may use those indications to define the shape, size and/or locations at which the touch areas 847 are positioned. In embodiments in which the touch areas 847 coincide with the narrow areas 838 in addition to the wide areas 839 (e.g., where an operator is given the option to cause the touch areas 847 to coincide with the narrow areas 838 to enable the use of a stylus), the presentation component 548 may also provide the touch component with indications of the shape, size and/or locations at which the narrow areas 838 are positioned. The touch component 547 then monitors the touch element 571 to detect instances of a touch at a touch area 847 to select a corresponding list item 834, and provides the application routine 510 with an indication of that selection.

FIG. 11 illustrates one embodiment of a logic flow 2100. The logic flow 2100 may be representative of some or all of the operations executed by one or more embodiments described herein. More specifically, the logic flow 2100 may illustrate operations performed by the processor component 550 in executing at least the UI routine 540, and/or performed by other component(s) of the computing device 500, in effecting a visual portion of a GUI.

At 2110, a processor component of a computing device (e.g., the processor component 550 of the computing device 500) receives item data (e.g., the item data 330), of which at least a portion is to be presented on a touch screen (e.g., the touch screen 580) as list items of a list (e.g., as the list items 834 of one of the above embodiments of the list 832). As previously discussed, the item data may be any of a variety of types of data, including and not limited to, email addresses and/or other indications of destinations to which to electronically send information, physical addresses of locations, names of persons, titles of books or other creative works, collected or raw data, results of calculations, entries of a list or chapters or an index, etc.

At 2120, the narrow thickness dimension of the narrow areas and the wide thickness dimensions of the wide areas are determined (e.g., the narrow thickness dimension 818 of the narrow areas 838 and the wide thickness dimension 819 of the wide areas 839) as part of determining the shape and/or size of the presentation areas of each of the list items (e.g., the presentation areas 837). As previously discussed, one or both of the narrow and wide thickness dimensions may be based on a size of a font to be used in visually presenting the item text of each of the list items (e.g., the item text 836). The narrow thickness dimension may be more directly determined by a height of tall character(s) of the font, and the wide thickness dimension may be calculated (e.g., by multiplication with a constant) from the narrow thickness dimension.

At 2130, the lengthwise dimension of the list may be determined. As previously discussed, the lengthwise dimension of the list may be longer or shorter based on the quantity of list items to be visually presented. As also previously discussed, in some embodiments of the list, the lengthwise dimension may be derivable by multiplying the narrow thickness dimension by the quantity of list items to be visually presented.

At 2140, a minimum width required for the list to be wide enough to visually present the longest of the item texts is determined. As previously discussed, the presentation areas of the list items have a generally elongate shape that is oriented to extend across the width of the list. Thus, the lengths of the presentation areas of the list items are oriented to extend in parallel to the widthwise dimension of the list.

However, a check is then made at 2150 to determine if this minimum width is greater than a maximum width available for use in visually presenting the list. As previously discussed, the maximum width may be determined based on the available viewable area of the display element of the touch screen (e.g., the display element 581).

If the minimum width is greater than the maximum width, then the widthwise dimension of the list (e.g., the widthwise dimension 813) may be based on the maximum width at 2152. However, if the minimum width is not greater than the maximum width, then the widthwise dimension of the list may be based on the minimum width at 2154.

At 2160, alternating locations at which to position the wide areas along the lengths of their corresponding presentation areas (e.g., along the widthwise dimension of the list within each of the presentation areas) are determined based on the widthwise dimension. As previously discussed, in embodiments of the list in which the quantity of alternating locations for the wide areas is not limited to two (e.g., in embodiments in which the alternating locations are only at the opposing ends of the generally elongate presentation areas), the quantity of alternating locations may also be determined based on the widthwise dimension.

At 2170, boundary markers (e.g., the boundary markers 835) indicating the locations of at least the wide areas of the list items are visually presented for each list item on the display element as part of visually presenting the list. As previously discussed, the boundary markers may be made up of solid lines, dashed or dotted lines, corner markers, changes in color, etc. At 2180, the item texts for each of the list items are visually presented on the display element.

FIG. 12 illustrates one embodiment of a logic flow 2200. The logic flow 2200 may be representative of some or all of the operations executed by one or more embodiments described herein. More specifically, the logic flow 2200 may illustrate operations performed by the processor component 550 in executing at least the UI routine 540, and/or performed by other component(s) of the computing device 500, in effecting a touch input portion of a GUI.

At 2210, a processor component of a computing device (e.g., the processor component 550 of the computing device 500) defines touch areas on a touch-sensitive surface of a touch screen (e.g., the touch screen 580) to coincide with at least the wide areas of the presentation areas (e.g., the wide areas 839 of the presentation areas 837) of list items of a list (e.g., the list items 834 of one of the above embodiments of the list 832) on a display element of the touch screen (e.g., the display element 581). As previously discussed, the touch-sensitive surface may be a surface of a touch element (e.g., the touch element 871) made up of a transparent film incorporating resistive, capacitive or other touch-sensing technology that overlies the viewable area of the display element. Alternatively, the touch element may include a set of light emitters and receivers arranged about the periphery of the viewable area of the display element to generate a grid of beams of light that sense a touch of the display element (or of a protective overlay of the display element) by monitoring for indications of interruptions of one or more of the beams.

If, at 2220, the touch areas are meant to coincide with the narrow areas of the presentation areas (e.g., the narrow areas 838), in addition to coinciding with the wide areas, then the touch areas are extended to also coincide with the narrow areas corresponding to the wide areas, the narrow areas being visually presented along with the wide areas. As previously discussed, whether the touch areas also coincide with the narrow areas may be made an option that is selectable by an operator (e.g., where the operator may desire to select a list item by touching a narrow area with a stylus). Regardless of whether the touch areas coincide with only the wide areas, or also coincide with the narrow areas, the touch areas are monitored for indications of a touch to select a corresponding list item at 2230.

FIG. 13 illustrates an embodiment of a processing architecture 3000 suitable for implementing various embodiments as previously described. More specifically, the processing architecture 3000 (or variants thereof) may be implemented as part of one or more of the computing devices 300 or 500, or the controller 700. It should be noted that components of the processing architecture 3000 are given reference numbers in which the last two digits correspond to the last two digits of reference numbers of at least some of the components earlier depicted and described as part of the computing devices 300 and 500, as well as the controller 700. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information over the communications media. The information can be implemented as transmissions allocated to one or more electrical and/or optical conductors. A message (including a command, status, address or data message) may be one of such transmissions or may be a plurality of such transmissions, and may be transmitted either serially or substantially in parallel through any of a variety of connections and/or interfaces.

As depicted, in implementing the processing architecture 3000, a computing device includes at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a touch screen 980 incorporating one or more of a touch element 971, a touch interface 975, a display element 981 and a display interface 985.

The coupling 955 includes one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which commands and/or data are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor components 350 and 550) may include any of a wide variety of commercially available processors, employing any of a wide variety of technologies and implemented with one or more cores physically combined in any of a number of ways.

As previously discussed, the storage 960 (corresponding to the storages 360 and 560) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as including multiple distinct types of storage is in recognition of the commonplace use of more than one type of storage device in computing devices in which one type provides relatively rapid reading and writing capabilities enabling more rapid manipulation of data by the processor component 950 (but in which a “volatile” technology may be used constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (which may correspond to the interfaces 190, 390 or 690) may employ any of a variety of communications technologies corresponding to any of a variety of communications technologies that may be employed to communicatively couple a computing device to one or more other devices. Again, one or both of various forms of wired or wireless communications may be employed to enable the processor component 950 to interact with input/output devices (e.g., the depicted example keyboard 920 or printer 925) and/or other computing devices, where such interaction may be through a network (e.g., the network 999) or an interconnected set of networks. In recognition of the often greatly different character of multiple types of timings and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data provided by those persons via gestures and/or facial expressions, laser printers, inkjet printers, mechanical robots, milling machines, etc.

Where a computing device is communicatively coupled to (or perhaps, actually incorporates) a touch screen (e.g., the depicted example touch screen 980, corresponding to the touch screen 580), such a computing device implementing the processing architecture 3000 may also include the display interface 985. Although more generalized types of interface may be employed in communicatively coupling to a display (whether of the touch screen variety, or not), the somewhat specialized additional processing often required in visually displaying various forms of content on a display, as well as the somewhat specialized nature of the cabling-based interfaces used, often makes the provision of a distinct display interface desirable. Wired and/or wireless communications technologies that may be employed by the display interface 985 in a communicative coupling of the touch screen 980 may make use of timings and/or protocols that conform to any of a variety of industry standards, including without limitation, any of a variety of analog video interfaces, Digital Video Interface (DVI), DisplayPort, etc.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method comprising:
presenting a list comprising multiple list items on a touch screen, each list item of the multiple list items associated with a touch area, and each list item comprising a wide area having a first thickness dimension marking a location of the associated touch area and a narrow area having a second thickness dimension narrower than the first thickness dimension, the wide and narrow areas adjoining to define a presentation area wherein:
the wide area of a first list item of the multiple list items is positioned at a first widthwise position of the presentation area of the first list item;
the wide area of a second list item of the multiple list items is positioned at a second widthwise position of the presentation area of the second list item;
the second list item is adjacent the first list item in the list; and
the first widthwise position differs from the second widthwise position along a widthwise dimension of the list;
defining the touch area of the first list item to coincide with the wide area of the first list item; and
defining the touch area of the second list item to coincide with the wide area of the second list item.

2. The computer-implemented method of claim 1, comprising positioning the first and second widthwise positions at opposing ends of an elongate shape of each of the presentation areas.

3. The computer-implemented method of claim 2, the elongate shape of the presentation areas comprising a wedge-like shape.

4. The computer-implemented method of claim 1, comprising presenting an item text in at least the narrow area of each list item.

5. The computer-implemented method of claim 1, comprising monitoring the touch areas associated with each of the multiple list items to detect an instance of a touch of a touch area associated with a list item of the multiple list items to select the list item.

6. The computer-implemented method of claim 1, the touch area associated with each list item to coincide with a portion of the narrow area of the list item beyond the wide area of the list item.

7. An apparatus comprising:
a processor component;
a presentation component for execution by the processor component to present a list comprising multiple list items arranged along a lengthwise dimension of the list on a touch screen, to position a first wide area of a first list item of the multiple list items at a first widthwise position of a first presentation area of the first list item, and to position a second wide area of a second list item of the multiple list items at a second widthwise position of a second presentation area of the second list item, the second list item adjacent the first list item in the list, and the second widthwise position differing from the first widthwise position along a widthwise dimension transverse to the lengthwise dimension; and
a touch component for execution by the processor component to define a first touch area associated with the first list item to coincide with the first wide area, and to define a second touch area associated with the second list item to coincide with the second wide area.

8. The apparatus of claim 7, the presentation component to present boundary markers to indicate at least a portion of an elongate shape of a presentation area of at least one of the multiple list items.

9. The apparatus of claim 7, the presentation component to present an item text in at least a narrow area of each list item of the multiple list items, the narrow area of each list item adjoining a wide area of each list item to define a presentation area of each list item, the presentation area having an elongate shape that extends across a width of the list, the wide area having a first thickness dimension wider than a second thickness dimension of the narrow area, and the first and second thickness dimensions extending along the lengthwise dimension.

10. The apparatus of claim 7, the touch component to monitor touch areas associated with each of the multiple list items to detect an instance of a touch of a touch area associated with a list item of the multiple list items to select the list item.

11. The apparatus of claim 7, the first presentation area comprising a first narrow area adjoining the first wide area to provide the first presentation area with an elongate shape, the first wide area having a first thickness dimension wider than a second thickness dimension of the first narrow area, and the second presentation area comprising a second narrow area adjoining the second wide area to provide the second presentation area with an elongate shape that interlocks with the elongate shape of the first presentation area, the second wide area having the first thickness dimension and the second narrow area have the second thickness dimension.

12. The apparatus of claim 11, first and second presentation areas having a wedge-like shape.

13. The apparatus of claim 11, the first and second wide areas having a convex shape, the first and second narrow areas having a concave shape, the convex shape of the first wide area extending into the concave shape of the second narrow area, and the convex shape of the second wide area extending into the concave shape of the first narrow area.

14. The apparatus of claim 11, the first and second wide areas having one of a circular shape, a rectangular shape and a convex shape.

15. The apparatus of claim 7, the touch screen comprising a display element on which the list is presented and a touch element co-located with the display element, the touch element comprising a touch-sensitive surface on which multiple touch areas associated with the multiple list items are defined.

16. At least one non-transitory machine-readable storage medium comprising instructions that when executed by a computing device, cause the computing device to:
present a list comprising multiple list items on a touch screen, each list item of the multiple list items associated with a touch area, and each list item comprising a wide area having a first thickness dimension marking a location of the associated touch area and a narrow area having a second thickness dimension narrower than the first thickness dimension, the wide and narrow areas adjoining to define a presentation area wherein:
the wide area of a first list item of the multiple list items is positioned at a first widthwise position of the presentation area of the first list item;
the wide area of a second list item of the multiple list items is positioned at a second widthwise position of the presentation area of the second list item;
the second list item is adjacent the first list item in the list; and
the first widthwise position differs from the second widthwise position along a widthwise dimension of the list;
define the touch area of the first list item to coincide with the wide area of the first list item; and
define the touch area of the second list item to coincide with the wide area of the second list item.

17. The machine-readable storage medium of claim 16, the computing device caused to position the first and second widthwise positions at opposing ends of an elongate shape of each of the presentation areas.

18. The machine-readable storage medium of claim 17, the elongate shape of the presentation areas comprising a wedge-like shape.

19. The machine-readable storage medium of claim 16, the computing device caused to present an item text in at least the narrow area of each list item.

20. The machine-readable storage medium of claim 16, the computing device caused to monitor the touch areas associated with each of the multiple list items to detect an instance of a touch of a touch area associated with a list item of the multiple list items to select the list item.

21. The machine-readable storage medium of claim 16, the touch area associated with each list item to coincide with a portion of the narrow area of the list item beyond the wide area of the list item.
